(19) United States
(12) Patent Application Publication
(10) Pub. No.: US 2007/0165395 A1
(43) Pub. Date: Jul. 19, 2007

(54) DIFFUSING PLATE HAVING A PLURALITY OF DOMAINS AND BACKLIGHT ASSEMBLY HAVING THE SAME

(75) Inventor: Byung-Choon Yang, Seongnam-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/537,999

(22) Filed: Oct. 2, 2006

(30) Foreign Application Priority Data
Jan. 18, 2006 (KR) 2006-5443

(51) Int. Cl. G09F 13/04

(52) U.S. Cl. 362/97

(57) ABSTRACT

A diffusing plate includes a body, a plurality of partitions and a diffusing member. The body has a lower face through which light enters the body and an upper face through which the light exits from the body. The body includes a plurality of domains having horizontal polygonal cross-sections. The partitions are disposed within the body. The partitions form the boundaries of the plurality of domains. The diffusing member is disposed between the lower face and the upper face of the body. The diffusing member is configured to diffuse the light entering the body to provide diffused light exiting the body. Therefore, the luminance uniformity of each domain is enhanced, and the interference between domains is minimized.

### CROSS-REFERENCE TO RELATED APPLICATIONS

This application relies for priority upon Patent Application No. 2006-5443 filed in the Korean Intellectual Property Office, Republic of Korea, on Jan. 18, 2006, the entire content of which is herein incorporated by reference.

### BACKGROUND OF THE INVENTION

1. Field of the Invention

The present invention relates to a diffusing plate and a backlight assembly having the diffusing plate. More particularly, the present invention relates to a diffusing plate for a display device having a plurality of domains and a backlight assembly having the diffusing plate.

2. Description of the Related Art

A liquid crystal display (LCD) device displays an image by using optical and electrical properties of liquid crystals. The LCD device has many advantages including a low profile, lightweight, low power consumption, and low driving voltage, etc. Therefore, an LCD device may be used in various applications.

An LCD panel of an LCD device is not self-emissive, so that the LCD panel requires a backlight assembly that provides the LCD panel with light. A backlight assembly may employ various light sources including a cold cathode fluorescent lamp (CCFL), a flat fluorescent lamp (FFL), a light emitting diode (LED), etc. An LED backlight has a relatively higher luminance and a relatively lower power consumption than other methods.

Recently, much research has focused on enhancing display quality and color-reproducibility of an LCD device by using the backlight assembly. An example of such research includes a color sequential display (CSD) method, a local dimming method, etc. According to the CSD method, various colors may be reproduced without using color filters. According to the local dimming method, a high contrast ratio may be obtained by locally adjusting luminance of the light source. A backlight assembly that includes a plurality of light sources with luminance may be adjusted to provide uniformity within local sections and to control interference between the local sections.

### SUMMARY OF THE INVENTION

According to one or more exemplary embodiments, the present invention provides a diffusing plate for a display device having a plurality of domains, and a backlight assembly for a display device having a plurality of domains. In one exemplary embodiment, a diffusing plate includes a body, a plurality of partitions and a diffusing member. The body has a lower face through which light enters the body and an upper face through which the light exits from the body. The body includes a plurality of domains having horizontal polygonal cross-sections. The partitions are disposed within the body. The partitions form the boundaries of the plurality of domains. The diffusing member is disposed between the lower face and the upper face of the body. The diffusing member is configured to diffuse the light entering the body to provide diffused light exiting the body. The domains may each have a substantially identical horizontal cross-sectional area and be adjacent to each other to compactly fill a two-dimensional space of the body. For example, the horizontal polygonal cross-section of at least one of the domains may have a regular hexagonal shape. Alternatively, the horizontal polygonal cross-section of at least one of the domains may have a regular triangular shape or a square shape. The partitions may comprise an upper portion and a lower portion, and the diffusing member may be disposed between the upper portion and the lower portion of the partitions. The lower portion of the partitions may have a reflecting layer coated thereon to prevent light from invading adjacent domains. The diffusing member may be separately formed in each of the domains, and the diffusing member may have a substantially identical horizontal cross-sectional shape with that of the domains. Alternatively, the diffusing member of each of the domains is integrally formed, so that the diffusing member penetrates one or more of the partitions, and the diffusing member may be disposed on the upper face of the body.

In a diffusing plate according to an exemplary embodiment of the present invention, the diffusing plate includes a body, a plurality of partitions and a diffusing member. The body has a lower face through which light enters the body and an upper face through which the light exits from the body. The body includes a plurality of domains having horizontal circular cross-sections. The partitions are disposed within the body and are configured to form the boundaries of the plurality of domains. The diffusing member is disposed between the lower face and the upper face of the body. The diffusing member is configured to diffuse the light entering the body to provide diffused light exiting the body. The domains may be adjacent to each other, and the centers of three domains adjacent to each other may form a regular triangular shape. The diffusing member may be independently formed in each of the domains, and the diffusing member has a horizontal circular cross-sectional shape.

In an exemplary backlight assembly according to an exemplary embodiment of the present invention, the backlight assembly includes a plate, a plurality of partitions, a diffusing member, a plurality of light sources and a driving substrate. The plate has a lower face through which light enters the body and an upper face through which the light exits from the plate. The plate includes a plurality of domains having horizontal polygonal cross-sections. The partitions are disposed within the plate. The partitions are configured to form the boundaries of the plurality of domains. The diffusing member is disposed between the lower face and the upper face of the body. The diffusing member is configured to diffuse the light entering the plate to provide diffused light exiting the plate. The light sources are correspondingly arranged with the plurality of domains. The driving substrate is disposed under the plate and is configured to drive the light sources.

The domains may have a substantially same horizontal cross-sectional area, and be adjacent to each other to compactly fill a two-dimensional space of the body. For example, the horizontal polygonal cross-section of one of the domains may have a regular hexagonal shape. The diffusing member may be separately formed in each of the domains, and the diffusing member may have a substantially identical horizontal cross-sectional shape with that of the domains. Alternatively, the diffusing member of each of the domains may be integrally formed, so that the diffusing member penetrates at least one of the partitions, and the diffusing member may be disposed on the upper face of the body.

The light sources may be inserted into the domains to be disposed between the diffusing member and the lower face of the plate. The light sources may be a plurality of light emitting diodes. In detail, the light emitting diodes may be white light emitting diodes emitting white light. Alternatively, the light sources may be a light emitting diode cluster including red light emitting diodes emitting red light, green light emitting diode emitting green light, and a blue light emitting diode emitting blue light. The light emitting diode cluster may further include a white light emitting diode emitting white light.

The backlight assembly may further include a control unit separately controlling the light emitting diodes. The control unit may include a circuit controlling luminance of the red light emitting diodes, the green light emitting diodes and the blue light emitting diodes in order to perform local dimming. The red light emitting diodes, the green light emitting diodes and the blue light emitting diodes may be repeatedly operated in sequence. Therefore, the backlight assembly may provide light portion-by-portion, and the backlight assembly may provide uniform light in the domains.

### BRIEF DESCRIPTION OF THE DRAWINGS

The above and other features and advantages of the present invention will become more apparent by describing in detailed example embodiments thereof with reference to the accompanying drawings, in which:

FIG. 1 is a perspective view illustrating an exemplary diffusing plate, according to an embodiment of the present invention;

FIG. 2 is a perspective view illustrating one of the domains in the diffusing plate shown in FIG. 1, according to an embodiment of the present invention;

FIG. 3 is a plan view illustrating the diffusing plate shown in FIG. 1, according to an embodiment of the present invention;

FIG. 4 is a cross-sectional view taken along a line I-I′ shown in FIG. 1, according to an embodiment of the present invention;

FIG. 5 is a plan view illustrating another exemplary diffusing plate, according to an embodiment of the present invention;

FIG. 6 is a plan view illustrating another exemplary diffusing plate, according to an embodiment of the present invention;

FIG. 7A is a plan view illustrating another exemplary diffusing plate, according to an embodiment of the present invention;

FIG. 7B is an enlarged view illustrating a portion ‘A’ shown in FIG. 7A, according to an embodiment of the present invention;

FIG. 8 is a perspective view illustrating one of the domains in the exemplary diffusing plate shown in FIGS. 7A and 7B, according to an embodiment of the present invention;

FIG. 9 is an exploded perspective view illustrating an exemplary backlight assembly, according to an embodiment of the present invention;

FIG. 10 is a cross-sectional view taken along a line II-II′ shown in FIG. 9, according to an embodiment of the present invention;

FIG. 11 is an enlarged plan view illustrating a portion ‘B’ shown in FIG. 9, according to an embodiment of the present invention;

FIG. 12A is a plan view illustrating an exemplary white light emitting diode in one domain of FIG. 11, according to an embodiment of the present invention; and

FIG. 12B is a plan view illustrating an exemplary LED cluster disposed in one domain of FIG. 11, according to an embodiment of the present invention.

### DESCRIPTION OF EXEMPLARY EMBODIMENTS

Exemplary embodiments of the present invention are described more fully hereinafter with reference to the accompanying drawings. The present invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” below,” “lower,” “above,” “upper” and the like, may be used herein for ease of description to describe one element or feature's relationship to another element(s) or feature(s) as illustrated in the figures.

It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device nor are they intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

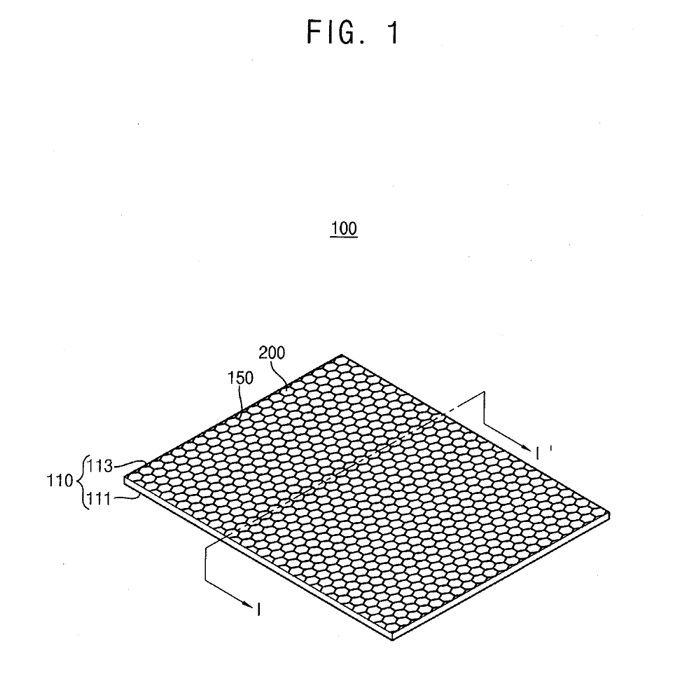

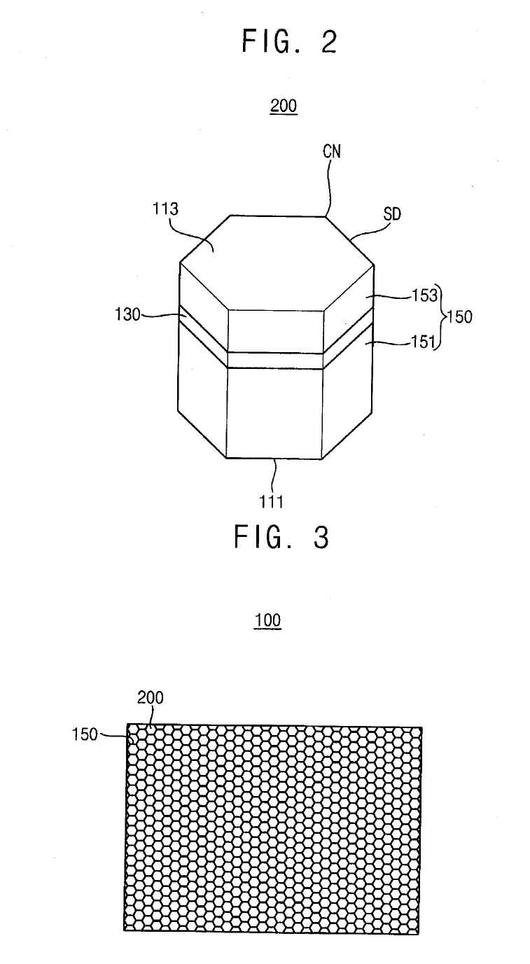

FIG. 1 is a perspective view illustrating an exemplary diffusing plate, according to an embodiment of the present invention. FIG. 2 is a perspective view illustrating one of the domains in the diffusing plate shown in FIG. 1, according to an embodiment of the present invention. FIG. 3 is a plan view illustrating the diffusing plate shown in FIG. 1, according to an embodiment of the present invention. Referring now to FIG. 1 to FIG. 3, a diffusing plate 100, according to an examplary embodiment of the present invention, includes a body 110, a plurality of partitions 150 and a diffusing member 130. The body 110 includes a plurality of domains 200. The partitions 150 surround the domains 200 to define the domains 200. The diffusing member 130 diffuses light generated from a light source (not shown) disposed under the diffusing member 130. The body 110 includes a lower face 111 and an upper face 113. Light generated from the light source (not shown) enters the body through the lower face 111, and exits from the body 110 through the upper face 113. The body 110 has a plate-shape, and includes a plurality of domains 200. The diffusing member 130 is disposed between the lower and upper faces 111 and 113 to diffuse light. A position of the diffusing member 130 may be adjusted based on a thickness of the body 110, a position of the light source (not shown), properties of light generated from the light source, etc. The diffusing member 130 includes an optically transparent material such as polycarbonate (PC), polymethylmethacrylate (PMMA), etc. The partitions 150 defining the domains 200 are disposed within the body 110. The partitions 150 surround the domains 200 to define the domains 200. In this manner, partitions 150 are configured to form the boundaries of the plurality of domains 200. The partitions 150 prevent light of one of the domains 200 from invading adjacent domains, so that interference of light is prevented. Furthermore, a luminance of light within each lighted domain is enhanced. The partitions 150 include an upper portion 153 and a lower portion 151. The diffusing member 130 is disposed between the upper portion 153 and the lower portion 151. In order to prevent light from invading adjacent domains, the partitions 150 may include an opaque material.

As shown in FIG. 3, each of the domains 200 is adjacent to each other such that the domains 200 compactly fill a two-dimensional area of the body 110. A horizontal cross-section of each of the domains 200 may have a polygonal profile or shape such as a hexagonal shape, a rectangular shape, and a triangular shape, etc. Preferably, each of the domains 200 has the same cross-sectional profile. According to one embodiment, and in order to provide uniform luminance throughout the plurality of domains 200 and even between domains 200, a horizontal cross-section of each of the domains 200 has a regular hexagonal shape. The regular hexagonal shape is appropriate for compactly filling two-dimensional spaces. Furthermore, the regular hexagonal shape is appropriate for enhancing luminance uniformity. Particularly, in comparison with a square shape and regular triangular shape, the regular hexagonal shape has a relatively smaller distance-variation between a first distance and a second distance, the first distance corresponding to a distance between a center of the regular hexagonal shape and a side SD, the second distance corresponding to a distance between the center of the regular hexagonal shape and a corner CN. As a result, a luminance is made uniform throughout the domains 200, and even between the domains 200.

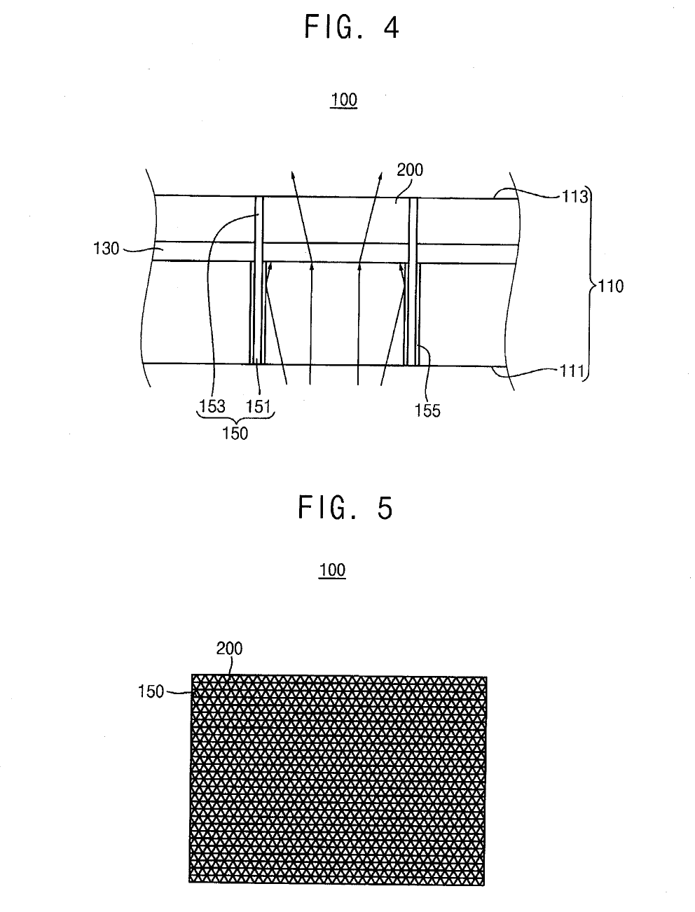

FIG. 4 is a cross-sectional view taken along a line I-I′ in FIG. 1, according to an embodiment of the present invention. In reference to FIG. 4, the diffusing plate 100 includes a body 110, a plurality of partitions 150 formed in the body 110 to define the domains 200 in the body 110, and a diffusing member 130 diffusing light generated from a light source (not shown) disposed under the diffusing member 130. As described above, the body 110 includes the lower face 111 through which light enters the body 110, and the upper face 113 through which the light exits from the body 110. The diffusing member 130 is disposed between the lower face 111 and the upper face 113 to diffuse the light. A position of the diffusing member 130 may be adjusted according to a thickness of the body 110, a position of the light source (not shown), properties of light generated from the light source, etc.

The partitions 150 defining the domains 200 are disposed within the body 110. The partitions 150 surround the domains 200 and form the domain boundaries. The partitions 150 prevent light of one of the domains 200 from invading adjacent domains, so that interference of light is prevented. Furthermore, a luminance of light of the domain is enhanced. The partitions 150 include the upper portion 153 and the lower portion 151. The diffusing member 130 is disposed between the upper portion 153 and the lower portion 151. In order to prevent light from invading adjacent domains, the lower portion 151 of the partitions 150 may further include a reflecting layer 155.

According to an embodiment of the present invention, the diffusing member 130 is separately formed in each of the domains 200, and the diffusing member 130 has a substantially identical cross-sectional shape with that of each of the domains 130. Alternatively, the diffusing member 130 of each of the domains 200 may be integrally formed with each other. Furthermore, the diffusing member 130 may be disposed on the upper face 113 of the body 110. As described above, when light sources of each of the domains 200 are separately controlled, and each of the body 110 of the diffusing plate 100 are divided into a plurality of domains defined by the partitions 150, light of each of the domains 200 is uniform and interference between the light of each of the domains 200 is minimized.

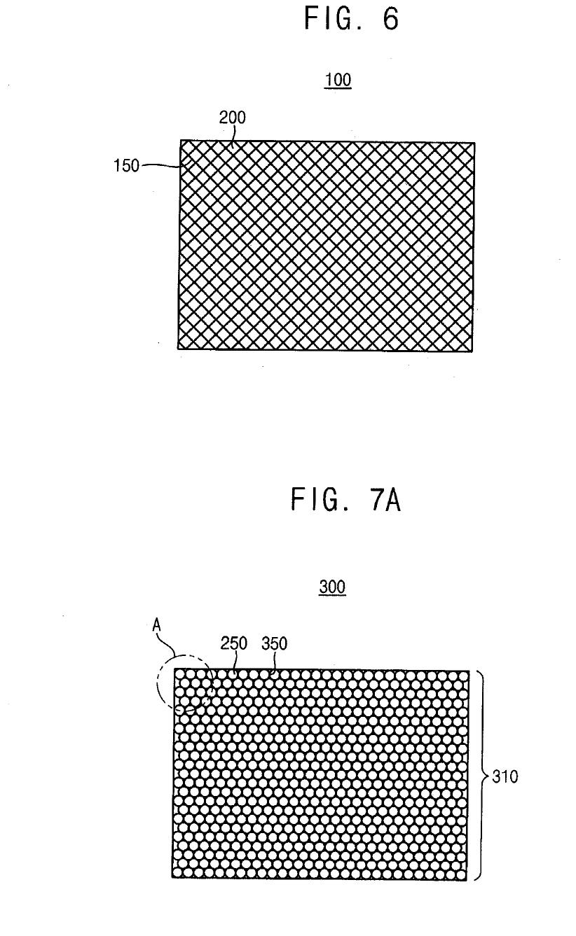

FIG. 5 is a plan view illustrating another exemplary diffusing plate, according to an embodiment of the present invention, and FIG. 6 is a plan view illustrating a diffusing plate according to an exemplary embodiment of the present invention. The diffusing plates in FIGS. 5 and 6 are same as the diffusing plate in FIGS. 1 to 4 except for a shape of each of the domains. Thus, the same reference numerals will be used to refer to the same or like parts as those described the diffusing plate in FIGS. 1 to 6, and any further explanation will be omitted. Referring to FIGS. 5 and 6, domains 200 are adjacent to each other, and compactly fill a two-dimensional space of the diffusing plate 100. The domains 200 in FIG. 5 have a regular triangular shape, and the domains in FIG. 6 have a square shape. The domains in FIG. 5 have same cross-sectional area, and the domains in FIG. 6 have same cross-sectional area. The partitions 150 defining the domains 200 are disposed in the body 110. The partitions 150 surround the domains 200 to define the domains 200. The partitions 150 prevent light of one of the domains 200 from invading adjacent domains, so that interference of light is prevented. Furthermore, a luminance of light of the domain is enhanced.

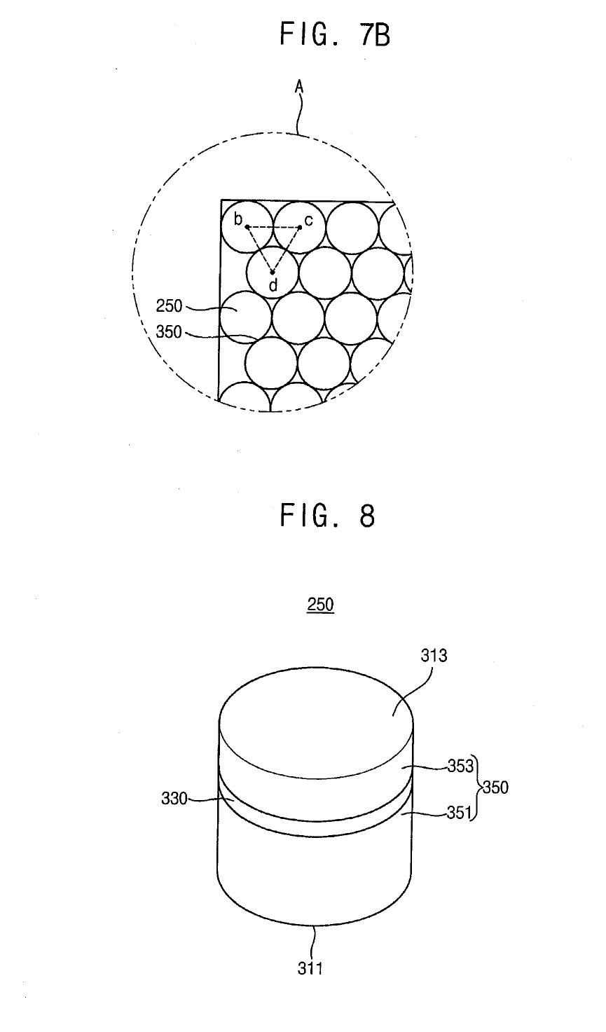

FIG. 7A is a plan view illustrating another exemplary diffusing plate, according to an example embodiment of the present invention, and FIG. 7B is an enlarged view illustrating a portion ‘A’ shown in FIG. 7A. FIG. 8 is a perspective view illustrating one of domains in the diffusing plate shown in FIGS. 7A and 7B, according to an embodiment of the present invention. Referring to FIGS. 7A, 7B and 8, a diffusing plate 300 according to the present example embodiment includes a body 310, a plurality of partitions 350 and a diffusing member 330. The body 310 includes a plurality of domains 250. The partitions 350 surround the domains 250 to define the domains 250. The diffusing member 330 diffuses light generated from a light source (not shown) disposed under the diffusing member 330. A cross-sectional shape of each of the domains 250 has a circular shape, and the domains 250 are arranged such that centers ‘b,’ ‘c’ and ‘d’ of three adjacent domains form a regular triangular shape.

The diffusing member 330 is disposed between the lower and upper faces 311 and 313 of the body 310 to diffuse light. A position of the diffusing member 330 may be adjusted according to a thickness of the body 310, a position of the light source (not shown), properties of light generated from the light source, etc. The diffusing member 330 includes an optically transparent material such as polycarbonate (PC), polymethylmethacrylate (PMMA), etc. The diffusing member 330 may be separately formed in each of the domains 250. Preferably, the domains 250 have a substantially similar or identical cross-sectional shape.

Unlike the domains 200 in FIGS. 1 to 3, the domains 250 of the present embodiment do not compactly fill the two-dimensional space of body 310. In other words, the domains 250 are adjacent to each other, but each of the domains 250 has a circular cross-sectional shape. Therefore, only portions of the partitions 250 surrounding the domains 250 make contact with each other. As a result, a region of the diffusing plate 300, which has no diffusing member 330, is formed. However, as described above, when each of the domains 250 has circular shapes, luminance of each domain is made uniform because a distance between a center and edge of a domain is uniform. Furthermore, when the domains 250 are arranged such that centers ‘b,’ ‘c’ and ‘d’ of three adjacent domains form a regular triangular shape, luminance of all domains throughout the diffusing plate 300 are made uniform.

The partitions 350 defining the domains 250 are disposed in the body 310. The partitions 350 surround the domains 250 to define the domains 250. The partitions 350 prevent light of one of the domains 250 from invading adjacent domains, so that interference of light is prevented. Furthermore, a luminance of light of the domain is enhanced. The partitions 350 include an upper portion 353 and a lower portion 351. The diffusing member 330 is disposed between the upper portion 353 and the lower portion 351. In order to prevent light from invading adjacent domains, the partitions 350 may include an opaque material.

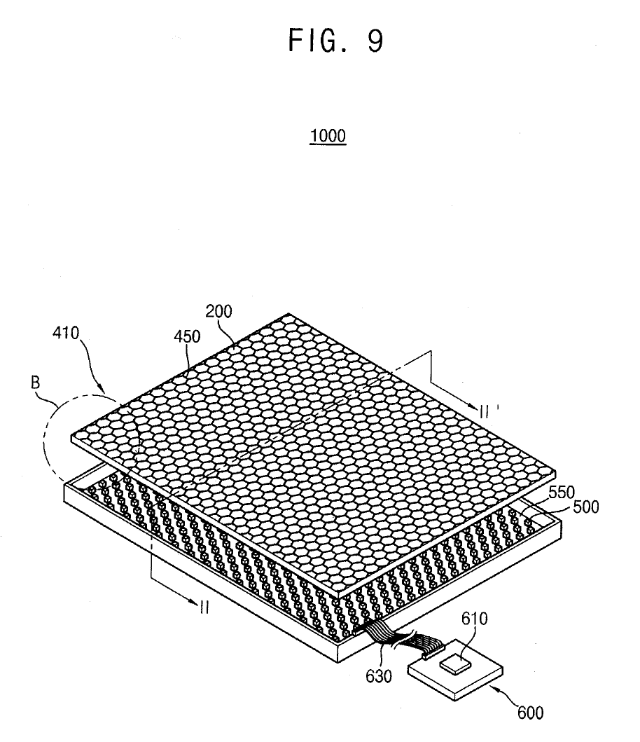

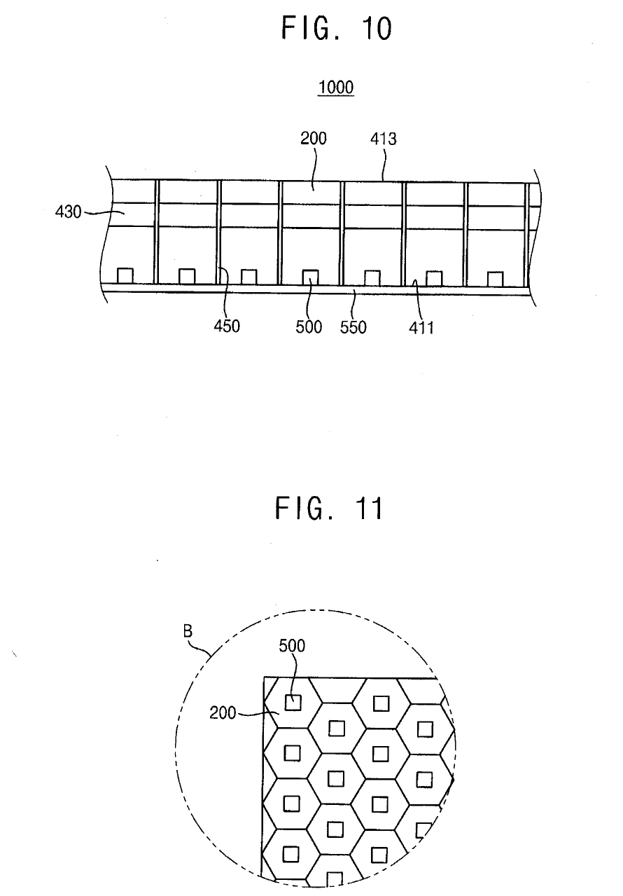

FIG. 9 is an exploded perspective view illustrating an exemplary backlight assembly, according to an embodiment of the present invention, and FIG. 10 is a cross-sectional view taken along a line II-II′ shown in FIG. 9. Referring to FIGS. 9 and 10, a backlight assembly 1000 according to an example embodiment of the present invention includes a plate 410 having a plurality of domains 200, a plurality of partitions 450 disposed in the plate 410 to surround the domains 200 in order to define the domains 200, a plurality of light sources 500 disposed in the domains respectively, a diffusing member 430 diffusing light generated from the light sources 500, and a driving substrate 550 for driving the light sources 500.

Each of the domains 200 is adjacent to each other such that the domains 200 compactly fill two-dimensional areas of the plate 410. A horizontal cross-section of each of the domains 200 may have a polygonal shape such as a hexagonal shape, a rectangular shape, and a triangular shape, etc. Preferably, each of the domains 200 has a substantially similar or identical cross-sectional area. A structure of the domains 200 is substantially the same as that in FIG. 2. Thus, further explanation will be omitted. The plate 410 includes a lower face 411 and an upper face 413. Light generated from the light source 500 enters the plate 410 through the lower face 411, and exits from the plate 410 through the upper face 413. The diffusing member 430 is disposed between the lower and upper faces 411 and 413 to diffuse light. A position of the diffusing member 430 may be adjusted according to a thickness of the plate 410, a position of the light source 500, properties of light generated from the light source, etc.

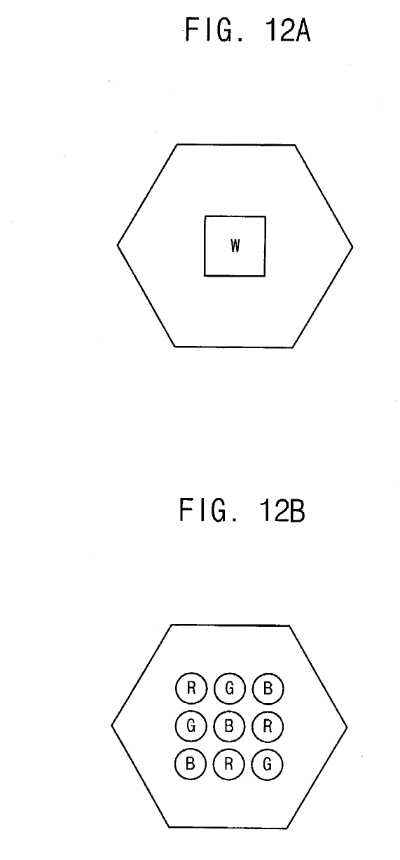

In the present embodiment, the diffusing members 430 are independently formed at each domain 200, and a cross-section of the diffusing member 430 is substantially the same as that of the domain 200. Alternatively, the diffusing members 430 may be integrally formed. An integrally formed diffusing member may pass through the partitions or be disposed on the partitions to cover all of the domains 200. The partitions 450 defining the domains 200 are disposed in the plate 410. The partitions 450 surround the domains 200 to define the domains 200. The partitions 450 prevent light of one of the domains 200 from invading adjacent domains, so that interference of light between domains is prevented. Furthermore, a luminance of light of the domain is enhanced. The light sources 500 are correspondingly arranged with the domains 200. For example, the light sources 500 are disposed in a central region of the domains 200, respectively. In the present embodiment, the light sources 500 are inserted into the domains 200 of the plate 410 to be disposed between the diffusing member 430 and the lower face 411 of the plate 410. Alternatively, the light sources 500 may be disposed under the lower face 411 of the plate 410. The driving substrate 550 is disposed under the plate 410. A receiving container for receiving the driving substrate 550 may be integrally formed with the driving substrate 550, so that the driving substrate 550 may receive the light sources 500. The driving substrate 550 drives the light sources 500. In the following, the light sources 500 and the driving substrate 550 will be explained referring to FIGS. 11 to 12B. As described above, when each of the domains having diffusing plate disposed therein is defined by the partitions, and light sources that are separately driven are disposed in the domains, respectively, luminance of the light generated from the light source is made uniform throughout the domains.

FIG. 11 is an enlarged plan view illustrating a portion ‘B’ shown in FIG. 9, according to an embodiment of the present invention. FIG. 12A is a plan view illustrating an exemplary white light emitting diode in one domain of FIG. 11, and FIG. 12B is a plan view illustrating an exemplary LED cluster disposed in one domain of FIG. 11. Referring to FIGS. 11, 12A and 12B, the light sources 500 are correspondingly arranged to the domains 200. The light sources 500 may be disposed in a central region of the domains 200, respectively. A white light emitting diode (LED) ‘W’ may be employed as the light sources 500 as shown in FIG. 12A. Alternatively, a red LED ‘R’, a green LED ‘G’ or a blue LED ‘B’ may be employed as the light sources 500. Furthermore, an LED cluster including a red LED ‘R’, a green LED ‘G’ or a blue LED ‘B’ may be employed as the light sources 500 as shown in FIG. 12B. The LED cluster includes a red LED ‘R’, a green LED ‘G’ or a blue LED ‘B’ to generate white light. The LED cluster may further include a white LED aside from a red LED ‘R’, a green LED ‘G’ and a blue LED ‘B’.

Referring again to FIG. 9, the driving substrate 550 is disposed under the plate 410, and the driving substrate 550 receives and drives the light sources 500. In the present embodiment, the LED is employed as the light source. The driving substrate 550 includes a power line (not shown) for transferring electric power to the LED 500, and a control signal line (not shown) for transferring an electric signal for turning on or off the LED. A plurality of LEDs 500 arranged on the driving substrate 550 is electrically connected to the power line and the control signal line. The backlight assembly 1000 may further include a control unit 600 to independently control some or all of the LEDs 500. The control unit 600 includes a driving circuit 610 and a connection wiring 630. The driving circuit 610 converts an external image signal into a light source control signal, and applies the light source control signal to the driving substrate 550 through a connection wiring 630. The driving substrate 550 separately controls the LEDs 500 in response to the light source control signal provided by the control unit 600. The control unit 600 may further include a circuit (not shown) for separately controlling a luminance of R-LED, G-LED and B-LED in order to perform local dimming. The backlight assembly 1000 according to the present invention may be employed by a display device operated in accordance with a color sequential display method operating R-LED, G-LED and B-LED in sequence to generate natural color, or a display device operated in accordance with a local dimming method controlling LEDs separately to enhance contrast ratio.

According to the present invention, the diffusing plate is divided into a plurality of domains surrounded by partitions, and each domain includes a diffusing member for the diffusing light. Therefore, luminance uniformity of each domain is enhanced, and interference between domains is minimized. Additionally, the backlight assembly according to the present invention may provide a display device displaying an image having different luminance values for different portions, or uniform light for every portion.

Having described the exemplary embodiments of the present invention and its advantages, it is noted that various changes, substitutions and alterations can be made herein without departing from the spirit and scope of the invention as defined by appended claims.

What is claimed is:

1. A diffusing plate, comprising:
a body having a lower face through which light enters the body and an upper face through which the light exits from the body, the body including a plurality of domains having horizontal polygonal cross-sections;
a plurality of partitions disposed within the body, the partitions being configured to form the boundaries of the plurality of domains; and
a diffusing member disposed between the lower face and the upper face of the body, the diffusing member being configured to diffuse the light entering the body to provide diffused light exiting the body.

2. The diffusing plate of claim 1, wherein the domains have a substantially identical horizontal cross-sectional area, the domains being adjacent to each other to compactly fill a two-dimensional space of the body.

3. The diffusing plate of claim 2, wherein the horizontal polygonal cross-section of at least one of the domains has a regular hexagonal shape.

4. The diffusing plate of claim 2, wherein the horizontal polygonal cross-section of at least one of the domains has one of a regular triangular shape or a square shape.

5. The diffusing plate of claim 2, wherein each partition comprises an upper portion and a lower portion, the diffusing member being disposed between the upper portion and the lower portion of the partitions, the lower portion of each partition having a reflective layer coated thereon to prevent light in one domain from invading an adjacent domain.

6. The diffusing plate of claim 1, wherein the diffusing member is separately formed in each of the domains, the diffusing member having a substantially identical horizontal cross-sectional shape with that of the domains.

7. The diffusing plate of claim 1, wherein the diffusing member of each of the domains is integrally formed, so that the diffusing member penetrates at least one of the partitions.

8. The diffusing plate of claim 1, wherein the diffusing member is disposed on the upper face of the body.

9. A diffusing plate, comprising:
a body having a lower face through which light enters the body and an upper face through which the light exits from the body, the body including a plurality of domains having horizontal circular cross-sections;
a plurality of partitions disposed within the body, the partitions being configured to form the boundaries of the plurality of domains; and
a diffusing member disposed between the lower face and the upper face of the body, the diffusing member being configured to diffuse the light entering the body to provide diffused light exiting the body.

10. The diffusing plate of claim 9, wherein the domains are adjacent to each other, the centers of three domains adjacent to each other forming a regular triangular shape.

11. The diffusing plate of claim 10, wherein the partitions comprises an upper portion and a lower portion, the diffusing member being disposed between the upper portion and the lower portion of the partitions, the lower portion of the partitions having a reflective layer coated thereon to prevent light in one domain from invading an adjacent domain.

12. The diffusing plate of claim 9, wherein the diffusing member is separately formed in each of the domains, the diffusing member having a horizontal circular cross-sectional shape.

13. A backlight assembly, comprising:
a plate having a lower face through which light enters the plate and an upper face through which the light exits from the plate, the plate including a plurality of domains having horizontal polygonal cross-sections;
a plurality of partitions disposed within the plate, the partitions being configured to form the boundaries of the plurality of domains;
a diffusing member disposed between the lower face and the upper face of the plate, the diffusing member being configured to diffuse the light entering the plate to provide diffused light exiting the plate;
a plurality of light sources correspondingly arranged with the plurality of domains; and
a driving substrate disposed under the plate, the driving substrate being configured to drive the light sources.

14. The backlight assembly of claim 13, wherein the light sources are inserted into the domains and disposed between the diffusing member and the lower face of the plate.

15. The backlight assembly of claim 13, wherein the light sources include a plurality of light emitting diodes.

16. The backlight assembly of claim 15, wherein the light emitting diodes are configured to emit white light.

17. The backlight assembly of claim 15, further comprising a control unit configured to independently control the light emitting diodes.

18. The backlight assembly of claim 17, wherein the control unit comprises a circuit configured to independently control the luminance of the light emitting diodes to provide local dimming.

19. The backlight assembly of claim 13, wherein the light sources comprise a light emitting diode cluster including red light emitting diodes emitting red light, green light emitting diode emitting green light, and a blue light emitting diode emitting blue light.

20. The backlight assembly of claim 19, further comprising a control unit configured to independently control the red light emitting diodes, the green light emitting diodes and the blue light emitting diodes.

21. The backlight assembly of claim 20, wherein the control unit comprises a circuit configured to control luminance of the red light emitting diodes, the green light emitting diodes, and the blue light emitting diodes in order to provide local dimming.

22. The backlight assembly of claim 20, wherein the red light emitting diodes, the green light emitting diodes and the blue light emitting diodes are configured for repeatedly sequential operation.

23. The backlight assembly of claim 19, wherein the light emitting diode cluster further comprises a white light emitting diode emitting white light.

24. The backlight assembly of claim 13, wherein the domains have a substantially identical horizontal cross-sectional area, the domains being adjacent to each other to compactly fill a two-dimensional space of the plate.

25. The backlight assembly of claim 24, wherein the horizontal polygonal cross-section of at least one of the domains has a regular hexagonal shape.

26. The backlight assembly of claim 24, wherein the horizontal polygonal cross-section of at least one of the domains has one of a regular triangular shape or a square shape.

27. The backlight assembly of claim 24, wherein each partition comprises an upper portion and a lower portion, the diffusing member being disposed between the upper portion and the lower portion of the partitions, the lower portion of the partitions having a reflective layer coated thereon to prevent light in one domain from invading an adjacent domain.

28. The backlight assembly of claim 13, wherein the diffusing member is separately formed in each of the domains, the diffusing member having a substantially identical horizontal cross-sectional shape with that of the domains.

29. The backlight assembly of claim 13, wherein the diffusing member of each of the domains is integrally formed, so that the diffusing member penetrates at least one of the partitions.

30. The backlight assembly of claim 13, wherein the diffusing member is disposed on the upper face of the plate.
